(19) United States
(12) Patent Application Publication
(10) Pub. No.: US 2024/0012674 A1
(43) Pub. Date: Jan. 11, 2024

(54) A METHOD, DEVICE AND SYSTEM OF CONTAINER CLUSTER SCALING

(71) Applicant: ZTE CORPORATION, Shenzhen, Guangdong (CN)

(72) Inventors: Baoguo XIE, Shenzhen (CN); Wei YAN, Shenzhen (CN); Manchang JU, Shenzhen (CN)

(73) Assignee: ZTE CORPORATION, Shenzhen, Guangdong (CN)

(21) Appl. No.: 18/312,187

(22) PCT Filed: Nov. 9, 2020
(86) PCT No.: PCT/CN2020/127518

§ 371 Date: May 4, 2023

(51) Int. Cl. G06F 9/455

(52) U.S. Cl. CPC G06F 9/45558; G06F 2009/4557; G06F 2009/45595

(57) ABSTRACT

A method for use in a container cluster management entity is disclosed. The method comprises performing a container cluster scaling operation on cluster instance resources in a container cluster instance in response to at least one triggering condition.

This document is directed generally to container cluster management, and more particularly to container cluster management in a network function virtualization (NFV) system.

In the existing NFV specifications, an NFV management and orchestration (NFV-MANO) is responsible for a lifecycle management of network service (NS) and virtual network function/virtual network function component (VNF/VNFC). During a VNF lifecycle management procedure (e.g. VNF instantiation procedure), a VNF manager (VNFM) manages VNF resources and requests resource authorization for VNF instantiation operations to an NFV orchestrator (NFVO) in accordance with resource information in an VNF descriptor (VNFD) template. After the NFVO resource authorization is passed, the VNFM requests a virtual infrastructure manager (VIM) to allocate corresponding virtual machine (VM) resources for the VNF instance. The VIM interacts with an infrastructure platform (i.e. network function virtualization infrastructure (NFVI)) to allocate resources for the NVF instance, and finally NFV-MANO completes the VNF instantiation and success to create a VM based VNF instance.

This document relates to a method, devices and a system of implementing container cluster scaling. In the NFV system, when a containerized VNF performs lifecycle management operations, the NFV-MANO is able to get sufficient cluster resources via the mechanism of the container cluster scaling, so as to complete related NS/VNF life cycle management operations (e.g. VNF instantiation operation and VNF auto-scaling operation).

The present disclosure relates to a method for use in a container cluster management entity. The method comprises performing a container cluster scaling operation on cluster instance resources in a container cluster instance in response to at least one triggering condition.

Various embodiments may preferably implement the following features:

Preferably, the at least one triggering condition comprises at least one of:
updating a container cluster descriptor template corresponding to the container cluster instance,
receiving, from a management entity, a request of performing the container cluster scaling operation on the cluster instance resources in the container cluster instance,
determining that available cluster instance resources of the container cluster instance are below a scaling threshold, or
determining that available cluster instance resources of the container cluster instance are insufficient for a cluster instance resource requirement of a container cluster instance requested by a network service or a virtualized network function instantiation operation.

Preferably, the scaling threshold is associated with a container cluster manager scaling policy pre-configured in the container cluster management entity.

Preferably, the method further comprises transmitting, to a container infrastructure service management entity, a request of determining a container resource requirement of the network service or the virtualized network function instantiation operation, and receiving, from the container infrastructure service management entity, the cluster instance resource requirement of the container cluster instance requested by the network service or the virtualized network function instantiation operation.

Preferably, the container cluster scaling operation on the cluster instance resource in the container cluster instance comprises at least one of:
generating at least one first node for the container cluster instance,
releasing at least one second node in the container cluster instance, or
expanding or reducing node resources of at least one third node in the container cluster instance,
wherein the node resources comprise at least one of computing resources, storage resources or network resources.

Preferably, the at least one second node in the container cluster instance is released, and the method further comprises transmitting, to a management and orchestration entity, an indication of transferring at least one network service or at least one virtualized network function instance running in the at least one second node to other nodes in the container cluster instance.

Preferably, the performing the container cluster scaling operation on the cluster instance resources in the container cluster instance in response to the at least one triggering condition comprises:
interacting with a virtualized infrastructure manager, VIM, for performing the container cluster scaling operation on the cluster instance resources in the container cluster instance, or
transmitting, to the VIM, a request of performing the container cluster scaling operation on the cluster instance resources in the container cluster instance

Preferably, the method further comprises updating the container cluster instance based on the scaled cluster instance resources of the container cluster instance.

Preferably, the container cluster instance based on the scaled cluster instance resources of the container cluster instance comprises at least one of:
adding at least one first node to the container cluster instance,
deleting at least one second node from the container cluster instance, or
updating node resources allocated to at least one third node in the container cluster instance.

Preferably, the method further comprises updating runtime information associated with the scaled cluster instance resources of the updated container cluster instance, and transmitting, to a management entity, at least one of a notification indicating that the container cluster instance is updated or the runtime information of the updated container cluster instance.

Preferably, the cluster instance resources are associated with at least one of the number of nodes in the container cluster instance or node resources of the nodes in the container cluster instance and the node resources comprise at least one of computing resources, storage resources or network resources.

The present disclosure relates to a method for use in a management and orchestration entity The method comprises:
determining that available cluster instance resources of a container cluster instance are below a scaling threshold, and
transmitting, to a management entity, a request of performing a container cluster scaling operation on cluster instance resources in the container cluster instance.

Various embodiments may preferably implement the following features:

Preferably, the scaling threshold is associated with a management and orchestration scaling policy pre-configured in the management and orchestration entity.

Preferably, the container cluster scaling operation on the cluster instance resources in the container cluster instance comprises at least one of:
generating at least one new node for the container cluster instance, or
expanding node resources of at least one existing node in the container cluster instance,
wherein the node resources comprise at least one of computing resources, storage resources or network resources.

Preferably, the management entity comprises an operation support system or a container cluster management entity.

Preferably, the container cluster scaling operation is associated with at least one of at least one new node for the container cluster instance or node resources of at least one existing node in the container cluster instance, and the node resources comprise at least one of computing resources, storage resources or network resources.

The present disclosure relates to a computing device comprising a communication unit, and a processor, configured to perform a container cluster scaling operation on cluster instance resources in a container cluster instance in response to at least one triggering condition.

Various embodiments may preferably implement the following feature:

Preferably, the computing device is further configured to perform any foregoing method.

The present disclosure relates to a computing device comprising a processor, configured to determine that available cluster instance resources of a container cluster instance are below a scaling threshold, and a communication unit, configured to transmit, to a management entity, a request of performing a container cluster scaling operation on cluster instance resources in the container cluster instance.

Various embodiments may preferably implement the following feature:

Preferably, the computing device is further configured to perform any foregoing method.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

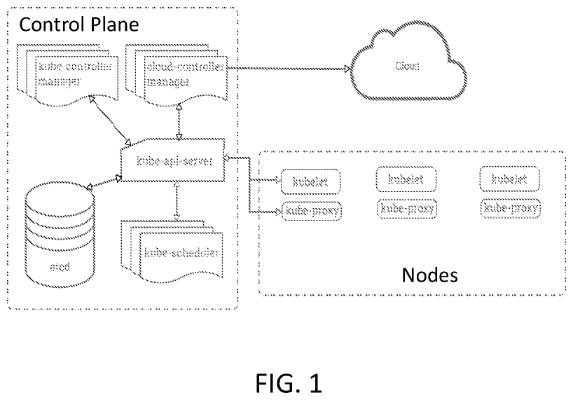

FIG. 1 shows a schematic diagram of a cluster including control plane and work nodes according to an embodiment of the present disclosure.

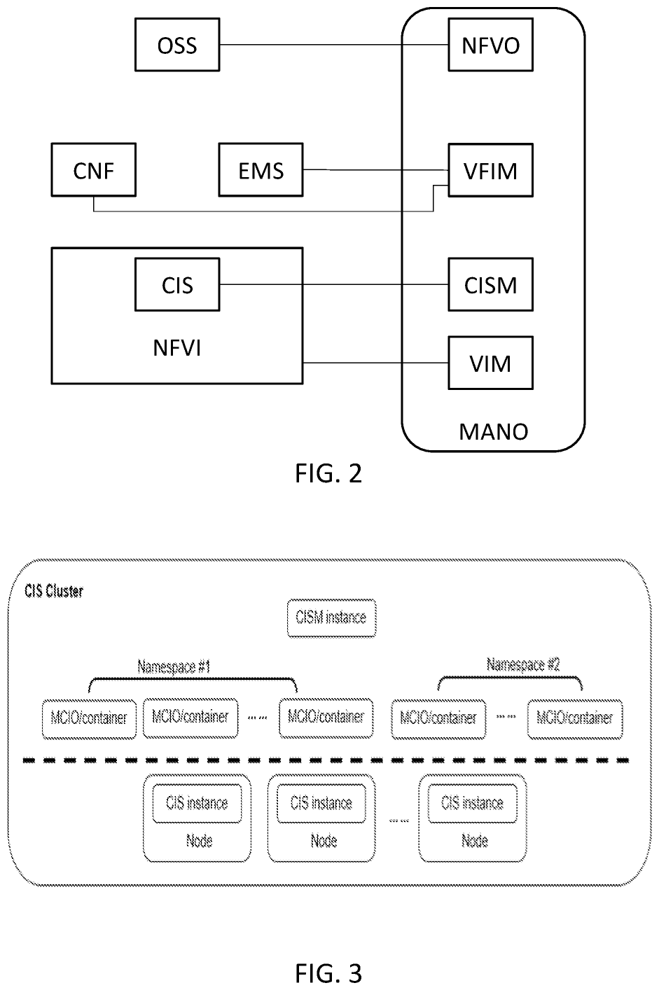

FIG. 2 shows a schematic diagram of an NFV system according to an embodiment of the present disclosure.

FIG. 3 shows an example of relationships among container infrastructure service (CIS) cluster, CIS manager (CISM), cluster node and CIS instance (CISI) according to an embodiment of the present disclosure.

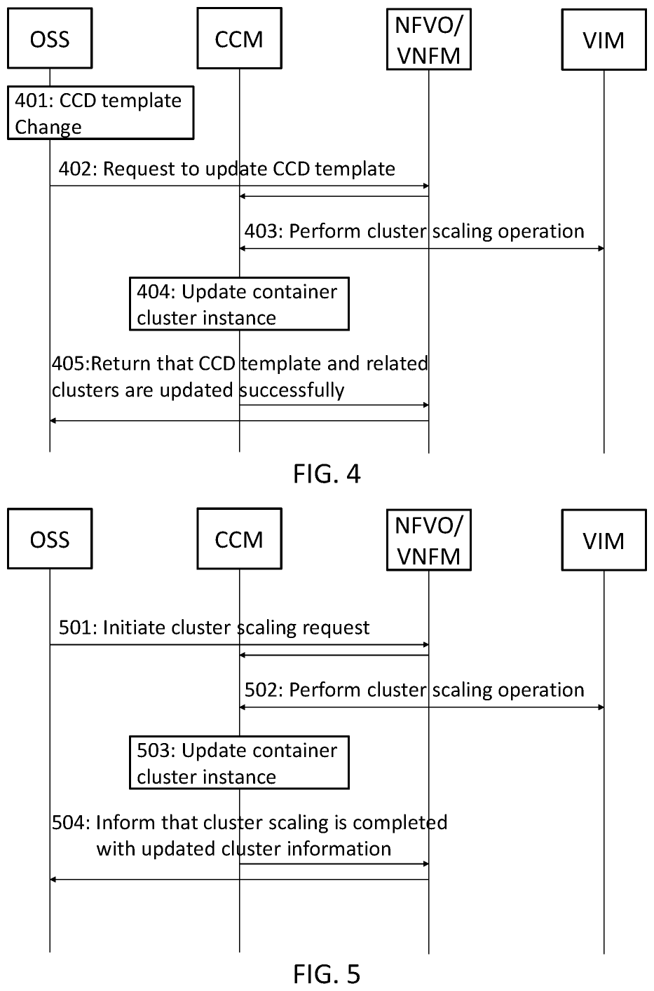

FIG. 4 shows a schematic diagram of triggering container cluster scaling through the container cluster descriptor (CCD) template update according to an embodiment of the present disclosure.

FIG. 5 shows an embodiment of operation support systems initiating the container cluster scaling request against a container cluster instance according to the service requirement.

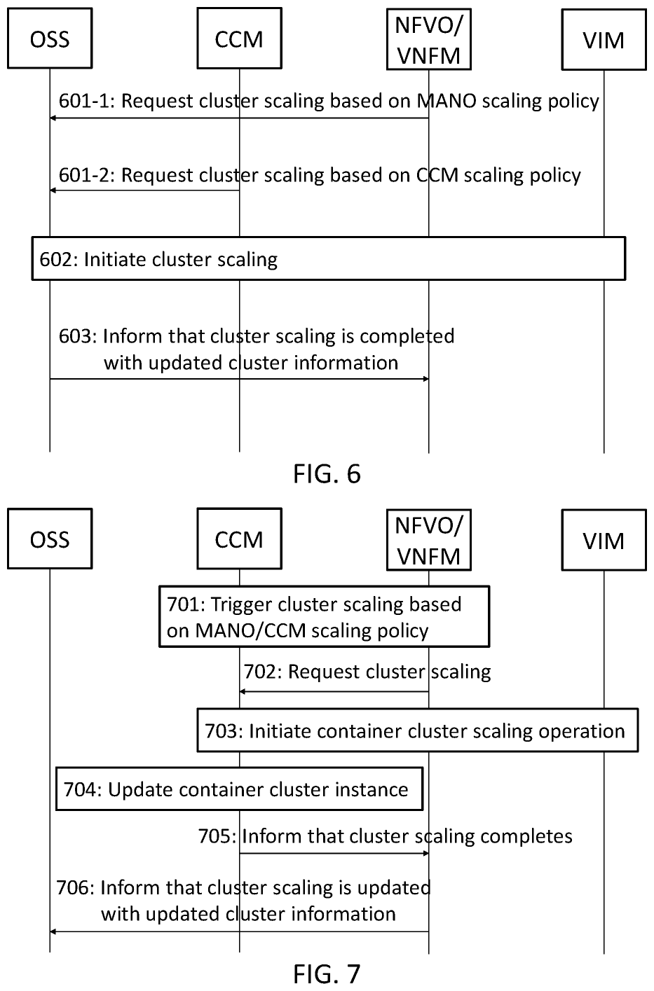

FIG. 6 shows an embodiment of MANO/CCM (management and orchestration/container cluster manager) requesting OSS (operation support systems) to initiate the container cluster scaling operation based on MANO scaling policy or CCM scaling policy.

FIG. 7 shows an embodiment of the MANO/CCM initiating the container cluster scaling operation directly based on MANO scaling policy or CCM scaling policy.

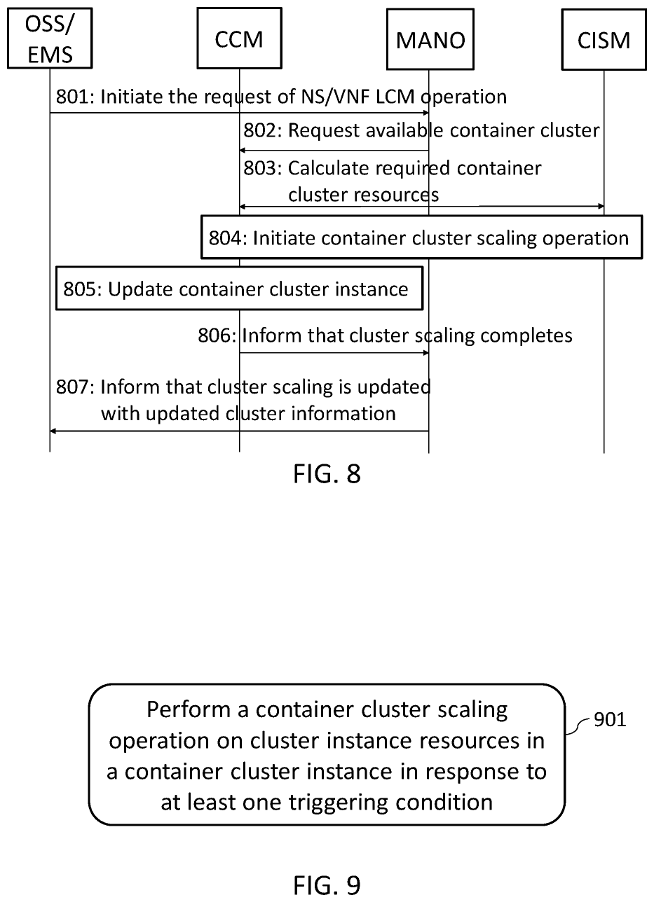

FIG. 8 shows an embodiment of the OSS requesting the containerized NS (network service) or VNF (virtualized network function) instantiation operation or the VNF and Element Management System (EMS) triggering the VNF scaling operation.

FIG. 9 shows a flowchart of a process according to an embodiment of the present disclosure.

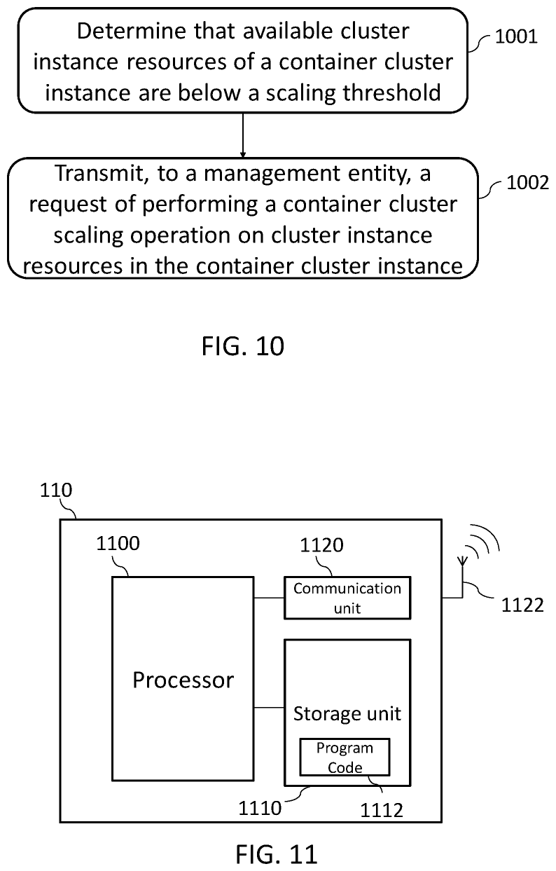

FIG. 10 shows a flowchart of a process according to an embodiment of the present disclosure.

FIG. 11 shows a schematic diagram of a computing device according to an embodiment of the present disclosure.

FIG. 1 shows a schematic diagram of a cluster including control plane and work nodes according to an embodiment of the present disclosure. More specifically, in open-source technology, a cluster (e.g. Kubernetes® cluster) consists of a set of worker machines (which are also called nodes), that run control plane applications (e.g. Kube-schedule, Kube-apiserver, . . . , etc.) and containerized applications. Every cluster has at least one master node and at least one worker node. In the present disclosure, the master node may be equal to a container infrastructure service manager (CISM) and the work node may be equal to a container infrastructure service instance (CISI).

In an embodiment, the control plane's components running in the master node(s) make global decisions related to the cluster (e.g. scheduling), detect cluster events (e.g. starting up a new point of delivery (Pod)) and respond to cluster events.

In an embodiment, the worker node(s) hosts Pods that are the components of application workload. The control plane manages the worker nodes and the Pods in the cluster.

FIG. 2 shows a schematic diagram of an NFV system according to an embodiment of the present disclosure. In FIG. 2, the NFV system supports container-based management and orchestration.

More specifically, the functionality of CISM is assigned to new NFV-MANO functional block and the functionality of CISM has two main aspects:
Function A: The management of managed container infrastructure objects (e.g. Kubernetes® Pods) with a dynamic service resource allocation; and
Function B: The management of the virtualized resources exposed by the container runtime environment (i.e., container infrastructure service (CIS)). In an embodiment, function B is not exposed to consumers of the CISM.

In an embodiment, the CISI is the container infrastructure resources within NFVI Virtualization Layer and provides the container runtime environment.

In an embodiment, the CISM may interact with the CISI to create all managed container infrastructure objects which are the components of the container based VNF and allocate container resources for them when the container based VNF are performed life cycle management (LCM) operation (e.g. VNF instantiation).

FIG. 3 shows an example of relationships among CIS cluster, CISM, cluster node and CISI according to an embodiment of the present disclosure. In FIG. 3, the CIS cluster is composed of one CISM instance and one or more CIS instances. The CISM instance schedules managed container infrastructure objects (MCIOs) invoked by the VNF to corresponding cluster nodes in the CIS cluster.

In addition, the CIS cluster may be logically divided into one or more namespaces. According to an embodiment, one namespace provides a mechanism to isolate its grouped elements (e.g., MCIOs) from others from a viewpoint of multi-tenancy security and provides access control to the grouped elements. Note that, resources in the cluster nodes of one CIS cluster may be grouped into a namespace and may only belong to that namespace. Those resources are allocated to elements grouped in the namespace.

In an embodiment, the CISM instance provides service interfaces of namespace management and cluster node management to its higher-level consumers (e.g. northbound consumers) in the scope of the CIS cluster. The CISM instance may also enforce resource limits (i.e., namespace quota) on a namespace as requested by its higher-level consumer.

In an embodiment, the NFV system may comprise a container cluster manager (CCM) function used for managing container cluster instance(s). For ease of illustrations, the CCM function is represented by CCM hereinafter.

In an embodiment, a container cluster descriptor (CCD) template is defined for describing all attributes of a container cluster. The OSS may deliver the CCD template orchestrated according to service requirements to the CCM.

Based on the information described in the CCD template, the CCM creates the container cluster instance, e.g. when being requested. For creating the container cluster instance, the CCM may create the master nodes and work nodes for the container cluster instance and configure the computing resources, network resources and storage resources to the cluster instance, e.g., by interacting with the MANO (e.g. the VIM).

In the present disclosure, the function may be equal to a functional block and/or a network element and/or a network entity. In addition, the NFV architecture may be equal to the NFV system.

### Embodiment 1: Triggering Container Cluster Scaling Through the CCD Template Update

FIG. 4 shows a schematic diagram of triggering container cluster scaling through the CCD template update according to an embodiment of the present disclosure. In this embodiment, when the CCD template is updated, the CCM needs to trigger the container cluster scaling op erati on(s).

More specifically, in step 401, the OSS updates (e.g. adjusts, changes, alters) a CCD template used by container cluster instance(s). In an embodiment, the OSS may update resource information related to nodes (e.g. work nodes and/or master nodes) in the CCD template. For example, the OSS may update an increase and/or a decrease in at least one of the number of nodes and node resources (e.g. computing resources, storage resources and network resources) used by the nodes in the CCD template. As an alternative or in addition, the OSS may update configuration information and/or deployment information related to the nodes in the CCD template.

In step 402, the OSS initiates a CCD template update to the CCM through related MANO entities (e.g. NFVO or VNFM). Specifically, the OSS initiates (e.g. transmits, sends) a CCD template update request to the MANO entity (e.g. NFVO), to request updating the CCD template. In an embodiment, the CCD template update request carries (e.g. comprises, includes) information related to the updated CCD template (e.g. an identifier of the CCD template and/or updated information of updating the CCD template and/or the updated CCD template). The NFVO forwards the CCD template update request and/or the information related to the updated CCD template to the CCM and the CCM receives and saves the updated CCD template.

Step 403. After receiving the updated CCD template, the CCM initiates container cluster scaling operation(s) associated with the updated CCD template and updates container cluster instance(s) which is instantiated based on the CCD template. In an embodiment, the container cluster scaling operation comprises at least one of the following steps 403-1 and 403-2.

Step 403-1: Node quantity scaling (e.g. scaling-in and scaling-out)

In step 403-1, a node quantity (i.e. the number of nodes) in the CCD template may be updated (e.g. changed, adjusted or altered). Based on information associated with updating the node quantity in the CCD template, the CCM may expand or reduce the nodes of the container cluster instance instantiated based on the CCD template. That is, the CCM may add new node(s) to the container cluster instance instantiated based on the CCD template or delete existing node(s) from the container cluster instance instantiated based on the updated CCD template.

In an embodiment of adding the new node(s), the CCM may interact with the VIM entity of the MANO to request scaling up the node quantity of the container cluster instance instantiated based on the CCD template. For example, the CCM may transmit identifier(s) of new node(s) and resource parameters required by the new node(s) and invoke the VIM interface to request the creation of the new nodes and allocates resources to the new node(s). After the new node(s) is created, the VIM informs the CCM that the required new node(s) is created successfully.

In an embodiment of reducing the node(s), the CCM instructs the MANO to migrate (e.g. transfer) the NS/VNF instance running on the node(s) which will be deleted to other nodes in the container cluster instance and instructs the VIM to delete (e.g. release resources of) this node(s) in the container cluster instance. After deleting the node(s), the VIM informs the CCM that the node(s) is deleted and the CCM deletes the node(s) from the container cluster instance.

Steps 403-2: Node resources scaling (e.g. scaling-up or scaling-down)

In step 403-2, node resources (e.g. computing resources and/or storage resources and/or network resources) of at least one node in the CCD template may be updated (e.g. changed, adjusted or altered). According to the change information of node resources described in the CCD template, the CCM expands or reduces the nodes resources of at least one node in the container Cluster instance.

In an embodiment, the CCM interacts with the VIM to request the node resources scaling according to the change information of the Node resources in the CCD template. The CCM invokes the VIM interface to request the VIM to expand or reduce the node resources of at least one node. The VIM performs the resources update operation of the at least one node and informs the CCM after the node resources scaling is completed.

In step 404, the CCM performs a cluster instance updating operation. After receiving the node scaling completion message from the VIM, the CCM needs to update the container cluster instance.

In an embodiment of the number of nodes in the container cluster instance being increased, the CCM adds the new nodes to the container cluster instance and manage the new nodes in container cluster LCM (lifecycle management) operation, installs an open resource system (e.g. Kubernetes system) and images for the newly added nodes for making each of the newly added nodes become a CIS instance or a CISM, and creates network connectivity for the newly added nodes.

In an embodiment of the number of nodes in the container cluster instance being reduced, the CCM deletes the released nodes from the container cluster instance.

In an embodiment of the node resources changing, the CCM updates node resources of each node in the container cluster instance and manage the node resources in container cluster LCM operation.

After the container cluster instance updating operation is completed, the CCM regenerates (e.g. updates) cluster instance runtime information, which includes at least one of the node quantity, node resources (including total resources and resources usage) and a network topology of the container cluster instance.

In step 405, after the container cluster updating operation is completed, the CCM returns the CCD template update completion information to the NFVO/VNFM of the MANO. The NFVO/VNFM returns the CCD template update completion information and CCD related container cluster instances update completion information to the OSS, wherein the CCD template update completion information or CCD related container cluster instances update completion information may carry the regenerated cluster instances runtime information.

### Embodiment 2: OSS Initiating Container Cluster Scaling

FIG. 5 shows an embodiment of the OSS initiating the container cluster scaling request against a container cluster instance according to the service requirement. The scaling operation comprises adding or deleting nodes in the container cluster instance and/or expanding or reducing the node resources of the existing nodes in the container cluster instance.

More specifically, in step 501, the OSS initiates (e.g. transmits) a container cluster scaling request to the CCM through the entities related to the NFV-MANO (e.g. NFVO and/or VNFM). The container cluster scaling request may carry an identifier of the container cluster instance and/or cluster scaling information (e.g. the increase and/or decrease in the node quantity and/or node resources for the existing nodes).

In step 502, after receiving the container cluster scaling request, the CCM initiates the container cluster scaling operation for the container cluster instance. The CCM performs the container cluster scaling operation according to the cluster scaling information, wherein the container cluster scaling operation may include scaling operations associated with the node quantity and/or node resources of the container cluster instance. For details of the specific steps of the scaling operations associated with the node quantity and/or node resources of the container cluster instance, please refer to steps 403-1 (Node quantity scaling) and 403-2 (Node resource scaling).

In step 503, the CCM performs the cluster instance updating operation. Details of step 503 may be referred to those of step 404.

In step 504, after the container cluster scaling operation is completed, the CCM notifies the OSS that the scaling is completed through the related MANO entities (e.g. NFVO and/or VNFM), wherein, along with the notification, the CCM may transmit the identifier of the container cluster instance and the updated cluster instance runtime information of the container cluster instance.

### Embodiment 3: CCM or MANO Performing Container Cluster Scaling According to Scaling Policy

In an embodiment, the container cluster scaling operation may be triggered based on the scaling policy. For example, according to the scaling policy, the container cluster scaling operation may be triggered to meet requirements of service performance and/or operator cost when the available quantity of nodes in the container cluster instance is lower or higher than a scaling threshold or when the available node resources are lower or higher than the scaling threshold.

In an embodiment, the MANO entities (e.g. NFVO and/or VNFM) check whether the (available) node quantity and/or node resources in the container cluster instance meet the scaling threshold defined in a MANO scaling policy. If not, the container cluster scaling operation is triggered.

As an alternative or in addition, the CCM entity checks the (available) node quantity and/or node resources in the container cluster instance meet the scaling threshold defined in the CCM scaling policy. If not, the container cluster scaling operation is triggered.

### Embodiment 3-1: Requesting OSS for Performing Container Cluster Scaling Operation

FIG. 6 shows an embodiment of the MANO/CCM requesting the OSS to initiate the container cluster scaling operation based on MANO scaling policy or CCM scaling policy.

In step 601-1, the MANO-related entities (such as NFVO and/or VNFM) obtain dynamic information related to available cluster resources in the container cluster instance, judges (e.g. determines) whether the container cluster instance meets the scaling threshold defined in the MANO scaling policy, and triggers the container cluster scaling operation according to the MANO policy (e.g. the judgement results). In an embodiment, the MANO scaling policy is pre-configured in the MANO entities.

As an alternative or in addition, in step 601-2, the CCM entity obtains dynamic information related to available cluster resources in the container cluster instance, judges (e.g. determines) whether the container cluster instance meets the scaling threshold defined in the CCM scaling policy, and triggers the container cluster scaling operation according to the CCM policy (e.g. the judgement results). In an embodiment, the CCM scaling policy is pre-configured in CCM entity.

In step 602, the MANO-related entities (such as NFVO and/or VNFM) and/or the CCM entity initiates the container cluster scaling request to OSS, wherein the container cluster scaling request may comprise the identifier of container cluster instance and requirements associated with the changed quantity of the nodes and/or the changed node resources of the existing nodes.

In an embodiment, the OSS re-orchestrates and update the CCD template according to the container cluster scaling request and initiates the CCD template update request to the CCM through MANO related entities (e.g. NFVO or VNFM). The detailed processes of this embodiment may be referred to Embodiment 1.

As an alternative, according to the container cluster scaling request, the OSS directly initiates the container cluster scaling request to the CCM through the MANO related entities. The container cluster scaling request may comprise the identifier of the container cluster instance and cluster scaling information (e.g. the changed quantity of the nodes and/or the changed node resources of the existing nodes). The detailed processes of this embodiment may be referred to Embodiment 2.

In step 603, after the completion of container cluster scaling operation, the OSS receives a message indicating that the container cluster scaling operation is completed. In an embodiment of the MANO initiating the container cluster scaling operation, the OSS may notify the MANO the container cluster scaling success information, which comprises the identifier of the container cluster instance and corresponding cluster instance runtime information.

### Embodiment 3-2: CCM being Requested to Directly Perform Container Cluster Scaling

FIG. 7 shows an embodiment of the MANO/CCM initiating the container cluster scaling operation directly based on MANO scaling policy or CCM scaling policy.

In step 701, the MANO-related entities (e.g. NFVO and/or VNFM) and/or the CCM entity obtains the dynamic information associated with available cluster resources in the cluster instance resources, judges whether each of the container cluster resources meet the scaling threshold defined in the MANO scaling policy or CCM scaling policy, respectively, and triggers the container cluster scaling operation according to the MANO policy or CCM policy (e.g. step 601-1 and/or step 601-2).

In step 702, if the MANO-related entities (such as NFVO and/or VNFM) initiates the container cluster scaling operation, the MANO entity directly initiates the container cluster scaling request to the CCM, wherein the container cluster scaling request comprises the identifier of the container cluster instance and/or requirements associated with the changed quantity of nodes and/or changed resources of the existing nodes.

As an alternative or in addition, if the CCM entity initiates the container cluster scaling operation by itself, the CCM performs the container cluster scaling operation directly.

In step 703, the CCM performs the container cluster scaling operation for the container cluster instance(s). The detailed processes of step 703 may be referred to those of step 502.

In step 704, the CCM performs the cluster instance updating operation. The detailed processes of step 703 may be referred to those of step 503. Note that, the node deployment and node network information may use default configurations described in the CCD template.

In step 705, if the MANO entities initiate the container cluster scaling operation, the CCM notifies the MANO entities of the successful scaling information of the container cluster instance, which comprises the identifier of the container cluster instance and corresponding cluster instance runtime information.

In step 706, the CCM notifies the OSS that the container cluster scaling operation completed in a message. The CCM may transmit the identifier of the container cluster instance and corresponding cluster instance runtime information in the message.

### Embodiment 4: CCM Initiating Container Cluster Scaling During the VNF/NS Lifecycle Management Process

FIG. 8 shows an embodiment of the OSS requesting the containerized NS or VNF instantiation operation or the EMS (element management system) triggering the VNF scaling operation. In this embodiment, the MANO entity requests an available container cluster instance for VNF/NS lifecycle management from the CCM, e.g. by carrying the container resources requirements of the NS/VNF. If the CCM finds out that the available container resources of the container cluster instance do not meet the container resources requirements of NS/VNF, the CCM initiates the container cluster scaling operation.

More specifically, in step 801, the OSS initiates the request of containerized NS or VNF instantiation operation to the related entities (NFVO and/or VNFM) of the MANO (e.g. NFVO and/or VNFM). As an alternative or in addition, EMS initiate the VNF scaling operation to the VNFM.

In step 802, for the NS/VNF instantiation operation, the MANO requests available container cluster instance from the CCM. For example, the MANO may transmit the container resources information (e.g. container resources requirement) required for the NS/VNF instantiation operation.

For the VNF scaling operation, the VNFM may find out that available node resources in the container cluster instance of the VNF are insufficient during the VNF scaling operation. In such conditions, the VNFM requests the CCM to expand nodes resources of the container cluster instance. For example, the VNFM may transmit the container resources information required by the VNF scaling operation.

In step 803, the CCM requests the CISM to calculate the container cluster instance resources required for the NS/VNF instantiation and/or the VNF scaling operation. The CISM calculates the required container cluster instance resources according to the required container resources for the NS/VNF lifecycle management. In an embodiment, the required container cluster instance resources include required node quantity of new nodes and node resources information of the existing nodes. The CISM returns the required node quantity and node resources information of the container cluster instance to the CCM.

In step 804, for the NF/VNF instantiation operation, the CCM finds out that the available container cluster instance resources cannot meet the NS/VNF instantiation resource requirements. Based on the required new nodes quantity and existing nodes resources information, the CCM initiates the container cluster scaling operation, to request the node quantity and resources required by the NF/VNF instantiation operation. The detail of step 804 may be referred to step 502.

For the VNF scaling operation, the CCM directly initiates the container cluster scaling operation according to the required nodes quantity and node resources information, to request the node quantity and node resources required by the VNF scaling operation. The detail of step 804 may be referred to step 502.

In step 805, the CCM performs the cluster instance updating operation. The detail of step 804 may be referred to step 503.

In step 806, the CCM returns the identifier of the available container cluster instance to the MANO and informs the related MANO entities (such as NFVO and/or VNFM) to use this identified container cluster instance to continue the NS/VNF instantiation operation and/or VNF scaling operation.

In step 807, the CCM notifies the OSS that the container cluster instance is changed and transmits the identifier of the container cluster instance and corresponding cluster instance runtime information.

FIG. 9 shows a flowchart of a process according to an embodiment of the present disclosure. The process may be used in a CCM entity (i.e. CCM) and comprises the following step:

Step 901: Perform a container cluster scaling operation on cluster instance resources in a container cluster instance in response to at least one triggering condition.

In the process shown in FIG. 9, in response to (e.g. based on) at least one triggering condition, the CCM entity performs a cluster scaling operation on cluster instance resources of a container cluster instance. For example, the CCM entity may adjust cluster instance resources of the container cluster instance in response to at least one triggering condition

In an embodiment, the at least one triggering condition comprises at least one of:
A) updating a CCD template corresponding to the container cluster instance;
B) receiving, from a management entity, a request of performing the container cluster scaling operation on the cluster instance resources in the container cluster instance;
C) determining that available cluster instance resources of the container cluster instance are below a scaling threshold;
D) determining that available cluster instance resources of the container cluster instance are insufficient for a cluster instance resource requirement of a container cluster instance requested by an NS or a VNF instantiation operation.

That is, the CCM entity may perform the container cluster scaling operation when updating CCD template used for generating (e.g. creating) the container cluster instance (see, e.g., Embodiment 1). As an alternative or in addition, the CCM entity may perform the container cluster scaling operation when receiving the request of adjusting the at least one scale of the cluster instance resources in the container cluster instance from a management entity (e.g. OSS, MANO, NFVO, VNFM) (see, e.g., Embodiment 2 or step 601-1 in Embodiment 3-1). As an alternative or in addition, the CCM entity may perform the container cluster scaling operation when determining that available cluster instance resources of the container cluster instance are below the scaling threshold (see, e.g., step 601-2 in Embodiment 3-1). As an alternative or in addition, the CCM entity may perform the container cluster scaling operation when determining that available cluster instance resources of the container cluster instance are insufficient for (e.g. cannot meet, cannot satisfy) the cluster instance resource requirement of the container cluster instance requested by the NS or the VNF instantiation operation (see, e.g., Embodiment 4).

In an embodiment, the scaling threshold is associated with a CCM scaling policy pre-configured in the CCM entity.

In an embodiment, the CCM entity may transmit, to a container infrastructure service management entity (e.g. CISM), a request of determining a container resource requirement of the NS or the VNF instantiation operation. The CCM entity receives the cluster instance resource requirement of the container cluster instance requested by the NS or the VNF instantiation operation from the container infrastructure service management entity.

In an embodiment, the container cluster scaling operation on the cluster instance resource in the container cluster instance comprises at least one of:
A) generating at least one first node (e.g. new node) for the container cluster instance,
B) releasing at least one second node (e.g. the existing node) in the container cluster instance,
C) expanding or reducing node resources of at least one third node in the container cluster instance.

In an embodiment, the node resources comprise at least one of computing resources, storage resources or network resources.

In an embodiment of at least one second node being released, the CCM entity may transmits, to a MANO entity (e.g. MANO and/or NFVO and/or VNFM), an indication (e.g. a message, a signaling, an instruction) of transferring NS or VNF instance running in the at least one second node to other nodes in the container cluster instance.

In an embodiment, the CCM entity may interact with a VIM for performing the container cluster scaling operation on the cluster instance resources in the container cluster instance in response to the at least one triggering condition,

In an embodiment, the CCM entity may transmit, to the VIM, a request of performing the container cluster scaling operation on the cluster instance resources in the container cluster instance.

In an embodiment, after the container cluster scaling operation completed, the CCM entity may update the container cluster instance based on the scaled cluster instance resources of the container cluster instance.

For example, the CCM entity may adding at least one first node (e.g. new node(s)) to the container cluster instance. As an alternative or in addition, the CCM entity may delete at least one second node (e.g. existing (nodes)) from the container cluster instance. As an alternative or in addition, the CCM entity may update node resources allocated to at least one third node in the container cluster instance.

In an embodiment, the CCM entity may update runtime information associated with the scaled cluster instance resources of the updated container cluster instance and transmit at least one of a notification indicating that the container cluster instance is updated or the runtime information of the updated container cluster instance to a management entity (e.g. OSS, MANO, NFVO VNFM or a network entity transmitting the request of performing the container cluster scaling operation or message associated with triggering the container cluster scaling operation).

In an embodiment, the cluster instance resources are associated with at least one of the number of nodes (e.g. node quantity) in the container cluster instance or node resources of the nodes in the container cluster instance, wherein the node resources comprise at least one of computing resources, storage resources or network resources.

FIG. 10 shows a flowchart of a process according to an embodiment of the present disclosure. The process may be used in a MANO entity (e.g. MANO, NFVO or VNFM) and comprises the following steps:

Step 1001: Determine that available cluster instance resources of a container cluster instance are below a scaling threshold.

Step 1002: Transmit, to a management entity, a request of performing a container cluster scaling operation on cluster instance resources in the container cluster instance.

More specifically, the MANO entity may obtain dynamic information of available cluster instance resources of a container cluster instance and determine whether the available cluster instance resources of the container cluster instance meet (e.g. satisfy) MANO scaling policy (see, e.g., step 601-1 in Embodiment 3-1). When the MANO entity determines that the available cluster instance resources of the container cluster instance are below a scaling threshold associated with the MANO scaling policy, the MANO entity transmits a request of performing a container cluster scaling operation on cluster instance resources in the container cluster instance to a management entity (e.g. CCM or OSS).

In an embodiment, MANO scaling policy is pre-configured in the MANO entity.

In an embodiment, the container cluster scaling operation on the cluster instance resources in the container cluster instance comprises at least one of:
A) generating at least one new node for the container cluster instance;
B) expanding node resources of at least one existing node in the container cluster instance, wherein the node resources comprise at least one of computing resources, storage resources or network resources.

In an embodiment, the cluster instance resources are associated with at least one of the number of nodes (e.g. node quantity) in the container cluster instance or node resources of the nodes in the container cluster instance, wherein the node resources comprise at least one of computing resources, storage resources or network resources.

FIG. 11 relates to a schematic diagram of a computing device 110 according to an embodiment of the present disclosure. The computing device 110 may be used to implement any one of aforementioned methods of the present disclosure. That is, the computing device 110 may comprise at least one network entity such as at least one of the CCM, the OSS, the VIM, the NFV-MANO, the NFVO, the VNFM, the EMS, the CISM. For example the computing device 110 may be able to perform all of functionalities of at least one network entity such as at least one of the CCM, the OSS, the VIM, the NFV-MANO, the NFVO, the VNFM, the EMS, the CISM. In FIG. 11, the computing device 110 may include a processor 1100 such as a microprocessor or ASIC, a storage unit 1110 and a communication unit 1120. The storage unit 1110 may be any data storage device that stores a program code 1112, which is accessed and executed by the processor 1100. Examples of the storage unit 1112 include but are not limited to a SIM, ROM, flash memory, RAM, hard-disk, and optical data storage device. The communication unit 1120 may be a transceiver and is used to transmit and receive signals (e.g. messages or packets) according to processing results of the processor 1100. In an example, the communication unit 1120 transmits and receives the signals via at least one antenna 1122 shown in FIG. 11.

In an embodiment, the storage unit 1110 and the program code 1112 may be omitted. The processor 1100 may include a storage unit with stored program code.

The processor 1100 may implement any steps described in exemplified embodiments on the wireless network node 110, e.g., via executing the program code 1112.

The communication unit 1120 may be a transceiver. The communication unit 1120 may as an alternative or in addition be combining a transmitting unit and a receiving unit configured to transmit and to receive, respectively, signals to and from another computing device (e.g. the CCM and/or the VIM and/or the OSS and/or the NFV-MANO and/or the NFVO and/or the VNFM and/or the EMS and/or CISM and/or the computing device performing all of the functions of the CCM and/or the OSS and/or the VIM and/or the NFV-MANO and/or the NFVO and/or the VNFM and/or the EMS and/or the CISM).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method for use in a container cluster management entity, the method comprising:
performing a container cluster scaling operation on cluster instance resources in a container cluster instance in response to at least one triggering condition.

2. The method of claim 1, wherein the at least one triggering condition comprises at least one of:
updating a container cluster descriptor template corresponding to the container cluster instance,
receiving, from a management entity, a request of performing the container cluster scaling operation on the cluster instance resources in the container cluster instance,
determining that available cluster instance resources of the container cluster instance are below a scaling threshold, or
determining that available cluster instance resources of the container cluster instance are insufficient for a cluster instance resource requirement of a container cluster instance requested by a network service or a virtualized network function instantiation operation.

3. The method of claim 2, wherein the scaling threshold is associated with a container cluster manager scaling policy pre-configured in the container cluster management entity.

4. The method of claim 2, further comprising:
transmitting, to a container infrastructure service management entity, a request of determining a container resource requirement of the network service or the virtualized network function instantiation operation, and
receiving, from the container infrastructure service management entity, the cluster instance resource requirement of the container cluster instance requested by the network service or the virtualized network function instantiation operation.

5. The method of any one of claims 1 to 4, wherein the container cluster scaling operation on the cluster instance resource in the container cluster instance comprises at least one of:
generating at least one first node for the container cluster instance,
releasing at least one second node in the container cluster instance, or
expanding or reducing node resources of at least one third node in the container cluster instance,
wherein the node resources comprise at least one of computing resources, storage resources or network resources.

6. The method of claim 5, wherein the at least one second node in the container cluster instance is released, and
wherein the method further comprises:
transmitting, to a management and orchestration entity, an indication of transferring at least one network service or at least one virtualized network function instance running in the at least one second node to other nodes in the container cluster instance.

7. The method of any one of claims 1 to 6, wherein the performing the container cluster scaling operation on the cluster instance resources in the container cluster instance in response to the at least one triggering condition comprises:
interacting with a virtualized infrastructure manager, VIM, for performing the container cluster scaling operation on the cluster instance resources in the container cluster instance, or
transmitting, to the VIM, a request of performing the container cluster scaling operation on the cluster instance resources in the container cluster instance.

8. The method of any one of claims 1 to 7, further comprising:
updating the container cluster instance based on the scaled cluster instance resources of the container cluster instance.

9. The method of claim 8, wherein the updating the container cluster instance based on the scaled cluster instance resources of the container cluster instance comprises at least one of:
adding at least one first node to the container cluster instance,
deleting at least one second node from the container cluster instance, or
updating node resources allocated to at least one third node in the container cluster instance.

10. The method of claim 8 or 9, further comprising:
updating runtime information associated with the scaled cluster instance resources of the updated container cluster instance, and
transmitting, to a management entity, at least one of a notification indicating that the container cluster instance is updated or the runtime information of the updated container cluster instance.

11. The method of any one of claims 1 to 10, wherein the cluster instance resources are associated with at least one of the number of nodes in the container cluster instance or node resources of the nodes in the container cluster instance, and
wherein the node resources comprise at least one of computing resources, storage resources or network resources.

12. A method for use in a management and orchestration entity, the method comprising:
determining that available cluster instance resources of a container cluster instance are below a scaling threshold, and
transmitting, to a management entity, a request of performing a container cluster scaling operation on cluster instance resources in the container cluster instance.

13. The method of claim 12, wherein the scaling threshold is associated with a management and orchestration scaling policy pre-configured in the management and orchestration entity.

14. The method of claim 12 or 13, wherein the container cluster scaling operation on the cluster instance resources in the container cluster instance comprises at least one of:
generating at least one new node for the container cluster instance, or
expanding node resources of at least one existing node in the container cluster instance,
wherein the node resources comprise at least one of computing resources, storage resources or network resources.

15. The method of any one of claims 12 to 14, wherein the management entity comprises an operation support system or a container cluster management entity.

16. The method of any one of claims 12 to 15, wherein the container cluster scaling operation is associated with at least one of at least one new node for the container cluster instance or node resources of at least one existing node in the container cluster instance, and
wherein the node resources comprise at least one of computing resources, storage resources or network resources.

17. A computing device, comprising:
a communication unit, and
a processor, configured to perform a container cluster scaling operation on cluster instance resources in a container cluster instance in response to at least one triggering condition.

18. The computing device of claim 17, wherein the processor is further configured to perform a method of any one of claims 2 to 11.

19. A computing device, comprising:
a processor, configured to determine that available cluster instance resources of a container cluster instance are below a scaling threshold, and
a communication unit, configured to transmit, to a management entity, a request of performing a container cluster scaling operation on cluster instance resources in the container cluster instance.

20. The computing device of claim 19, wherein the processor is further configured to perform a method of any one of claims 13 to 16.

21. A computer program product comprising a computer-readable program medium code stored thereupon, the code, when executed by a processor, causing the processor to implement a wireless communication method recited in any one of claims 1 to 16.
